(19) United States
(12) Patent Application Publication
(10) Pub. No.: US 2019/0362364 A1
(43) Pub. Date: Nov. 28, 2019

(54) SYSTEMS AND METHODS FOR ASSISTING IN THE SELECTION OF PRODUCTS AND/OR SERVICES

(71) Applicants: Mark GREENSTEIN, Bethesda, MD (US); Brian TARBOX, Minneapolis, MN (US)

(72) Inventors: Mark GREENSTEIN, Bethesda, MD (US); Brian TARBOX, Minneapolis, MN (US)

(21) Appl. No.: 16/534,379

(22) Filed: Aug. 7, 2019

Related U.S. Application Data
(62) Division of application No. 10/492,205, filed on Oct. 4, 2005, now abandoned.
(60) Provisional application No. 60/438,213, filed on Jan. 6, 2003.

(51) Int. Cl. G06Q 30/02; G06Q 30/06

(52) U.S. Cl. CPC G06Q 30/02; G06Q 30/0601; G06Q 30/0282

(57) ABSTRACT

A method, system and apparatus for addressing conflicted recommendations over the internet and then selling or leasing products or services.

### RELATED APPLICATIONS

This application is a divisional application of U.S. patent application Ser. No. 10/492,205, filed on Oct. 4, 2005, which is a National Stage Entry of PCT/US04/00004, filed on Jan. 6, 2004, which claims priority to provisional application 60/438,213, filed Jan. 6, 2003 (of which the entire disclosure of the pending prior application is hereby incorporated by reference).

### BACKGROUND OF THE DISCLOSURE

The present disclosure relates generally to an innovative purchasing and/or leasing program, which is designed to improve purchasing and/or leasing outcome satisfaction performance for individual consumers, including enabling individual consumers to optimize their purchasing/leasing decisions while minimizing the time including products/services criteria selection and research time necessary to arrive at the individuals approximately optimal decision, by providing appropriate purchasing/leasing criteria which is then evaluated pursuant to criteria established or reviewed by an independent third party that utilizes a computer program to identify, presently preferably, automatically identify at least one or more of a predetermined number of the available products/services that most closely meet the needs expressed and/or criteria provided by or on behalf of the individual consumers for the specific product/service being purchased/leased and may include a system, once an individual consumer so directs or in cases where a third party can direct on behalf of the individual consumer, without receiving direction from the individual consumer, for individual consumer, while eliminating or, at least, ameliorating the conflict of interest that would otherwise exist between a provider of the products/services and persons (e.g., sales people, marketing managers, business owners, etc.) that would under today's normal distribution channels, result in a lesser value, such as, for example, higher prices and/or suboptimal products and/or a cumbersome and/or inefficient selection process for the individual consumer in obtaining such products/services. The innovative purchasing and/or leasing program includes, but is not limited to, systems and methods that are computer housed software programs for collecting, monitoring and directing data from individual consumers and processing such against indicative data collected with respect to a plurality of consumer purchased and/or leased products/services, including, but not limited to, manufacturers, wholesalers, retailers, clearinghouses and affiliates of such entities and/or any other entities involved in the distribution of products and services to individual consumers.

The field of purchasing or leasing products or services has been greatly impacted by the explosion of related information and products that are now available, including information to assist with the purchase and/or leasing a variety of consumer products from, such as, for example, medication to motor vehicles. As a practical matter, the internet provides a very useful mechanism for individual consumers to purchase or lease product or services, once the individual consumer has the, presently preferably, precise specifications of the desired product or service. However, as is well known, the source of the information related to such purchase/lease decisions may be biased and/or unreliable, and the traditional distribution channel contains puffery, inflated advertising claims, and other inexact or misleading information. Further, it is very difficult to shop on the Internet for products or services absent such precise specifications.

The difficulty that this greater complexity presents to an individual consumer/purchaser was recently the subject of part of the Jim Lehr Newshour, on Dec. 26, 2003. That Newshour segment was entitled the “Paradox of Choice,” and was presented by a person who authored a book with the same title. One underlying premise was that more choice was perhaps not as positive development as many would have us believe because of the added cost of product/service selection in terms of time and inconvenience to the individual consumer, which transaction cost often exceeds the benefit of the increased choices. One possible solution that was suggested in the Newshour segment was to make a choice that is merely satisfactory, even though suboptimal.

As noted in the Newshour television show, optimally making a purchase or leasing decision is a complicated and time-consuming decision that typically involves a great deal of anxiety concerning whether an appropriate product or service has been selected and whether the price paid is the best price or a competitive price and whether the process is appropriately convenient. Studies by psychologists have shown that increasing the complexity and/or anxiety associated with a decision-making task leads individuals to defer making a decision, or to procrastinate, and/or to make sub-optimal decisions because the process that results in sub-optimal decisions are simpler as compared to the processes required for making optimal decisions.

There are believed to be at least two sources of complexity (which may increase the anxiety) in making the purchasing/leasing decisions, as described above. First, the array of products and/services to be evaluated by the individual consumer responsible for making the decision is immense, and the available information is frequently biased. Such individual consumer or the person responsible for making the decision must first choose the product or service that they want to purchase or lease with the knowledge that the information upon which they rely may be biased. Then the individual consumer or the person responsible for making the decision must determine where to purchase or lease the product or service and whether the price and/or convenience are favorable from the perspective of the individual consumer or the person responsible for making the decision, again with the knowledge that the information upon which they rely may be biased or at least not completely accurate.

Search engines result in considerable information concerning the products or services under consideration, but not an efficient purchasing/leasing process that answers the question typically posed by a purchaser/lessor, e.g., what is the best CD system I can buy for under $400 and where can I purchase this CD system. Also, the ranking/order of the information presented by a search engine may be influenced by payments made to the owners of the search engine and/or are not customized to the specifications of the purchaser/lessor. The commercial reality of the Internet can add to the inefficiency and self-interest typical in the selection of products and/or services today.

If the question concerning the most appropriate products and/or services to purchase or lease is posed to a person who sells or leases the products and/or services, this will result in a more convenient and less time-consuming purchase/leasing process. One identifiable problem is that the incentives for the person who sells/leases the products or services to individual consumers as well as for other persons involved in the process today is to maximize their profits, which typically does not achieve the best or optimum result for the purchaser/lessor. Researching the area concerning the purchase and/or lease generally requires an investment of considerable time endeavor, and frequently money, that most individual consumers would prefer to avoid.

In this connection, there are objective information sources available, such as, for example, Consumers' Reports and Washington Consumer Checkbook that do provide objective ratings and other objective information about products and services. However, the above mentioned sources for objective ratings and evaluations have to be purchased by the individual consumer and then accessed and researched in order for the individual consumer to effectively utilize these sources in the individual consumer's purchasing/leasing decisions. The process described above involves a complexity and cost in money and/or time that many individual consumers would prefer to avoid.

What is needed then is a more accessible and easily utilized purchasing/leasing decisions making process that approaches the purchasing/leasing problem from the perspective of the purchaser or lessor, which can be processed in a manner so that persons have the option of not separately paying for the third party expertise, or could pay for the third party expertise on a per transaction basis, or have persons who are involved in selling the products or services pay for the third party expertise. Also, such a process could provide a more customized purchasing/leasing decision solution based on information and/or preferences of the purchaser/lessor or the person who will utilize the products or services, which could include providing information and preferences that are particular to the persons who will utilize the products or services (rather than having to obtain a considerable quantity of information that is generally contained in general third party reviews/evaluations of products and/or services, typically including a great deal of information which is not relevant to an individual purchaser or lessor.

One possible solution to the above described situation includes providing a data processing system, originated, approved, reviewed and/or overseen by, or by criteria originated approved, reviewed, overseen and/or established by a person who is independent of the purchasing/leasing transaction(s) that includes software that collects, monitors and directs information from and/or regarding a person who wishes to purchase or lease products and/or services, so that the person (who may be a legal or natural person) is assisted in the purchase or lease of the appropriate products and/or services or a combination of both products and/or services, as may be appropriate. Such purchases/leases can be made automatically pursuant to standing instructions based on criteria that are constant or change over time or can be made after receiving instruction, including standing instructions, from the person or someone (who may be a legal or natural person) acting on behalf of the person with respect to the purchase/leasing transaction(s).

In the case of individual consumer purchasing/leasing decisions, including enabling individual consumers to optimize their purchasing/leasing decisions while minimizing the time including products/services criteria selection and research time necessary to arrive at the individual consumer's approximately optimal decision, marketers and manufacturers, with respect to product purchases and with respect to leasing transaction, have been primarily, if not totally, concerned with their profit/bottom line and the implications to the detriment of the individual consumer for some time. Available consumer education with respect to expanded product/service choices, the product/service specifications, Internet search software, online consumer product tools, etc. have mostly been produced with the goal of improving the overall profit of the various members of the products/services distribution channels and not to provide the individual consumer with access to his/her individual optimized purchase/lease which may reflect consideration of a combination of criteria and may include, but not be limited to, one or more of the following: the price at which the product/services may be purchased, and the ability of the goods/services to meet the needs of the consumer, and the convenience of the transaction (e.g., the time frame within which the goods or services will be provided).

Thus, there is a clear need for a new and innovative purchasing/leasing program that eliminates or at least significantly ameliorates this economic conflict of interest by, for example, providing for a separation between the entities or entity that sells/lease goods and/or services in the supply channels, provide information with respect to goods and/or services or are otherwise involved in the purchase or lease of goods and or services. Such a program should provide compensation for the critical functions of determining and appropriately weighting one or more of the different criteria that are important to the individual consumer purchaser/lessor, such as, for example, quality and/or price in a manner that reduces or eliminates conflicts of interest that are typically present, including those conflicts that result from receiving differing fees and profits depending on the goods and/or services purchased or leased.

### SUMMARY OF THE DISCLOSURE

The present disclosure provides systems and methods that enable an individual consumer to arrive at a superior solution to a purchasing/leasing decision without having to make subjective and often anxiety provoking decisions (which often results in indecision) of whether sufficient time has been devoted to the process and whether a satisfactory result has been achieved.

Therefore, an object of the present disclosure is to provide a solution to individuals including consumers, in optimizing their purchases and/or leases of goods and services.

Another object of the present disclosure is to provide the ability to collect indicative data from a variety of sources, including the individual (e.g., a consumer), which is used to determine appropriate goods and/or services for the individual such as a consumer.

The new and innovative purchasing/leasing program, which includes the present systems and methods, integrates the level of quality, cost and/or convenience in a manner that minimizes time effort and cost by individuals. Individuals may be assisted in providing their information and making appropriate decisions by a facilitator. The determination of the goods and/or services selected or recommended is determined by person(s) compensated in a manner, which is generally or totally separate and independent from other fee generating functions such as profits on the goods and/or services.

The systems and methods of the present disclosure eliminate or at least ameliorate possible economic conflict of interest by separating or, appropriately combining, the determination of relevant factors, including quality, cost and/or convenience from other fee generating such as profits on the sale or the goods and/or services functions such as the sale of the goods and/or services. The person(s) who determines or approves the ratings of the goods and/or services (e.g., an Independent Expert) receives fees that are generally or totally independent from the fees charged by other persons in the supply line of the goods and/or services. The Independent Person such as an Independent Expert is generally or totally independent from and unrelated to any other person who receives compensation in connection with the subject transactions, which transactions include a decision not to lease or purchase products and/or services. The systems and methods of the present disclosure can assure that other persons involved in the supply line are unaware of the data concerning the individual persons or the basis for rating the product and or services.

Such an new and innovative purchasing/leasing program should be implemented by separating or not separating advice and/or selection of products and/or services from those who benefit to varying degrees depending on the product and/or services selected and/or the manner in which such products and/or services are supplied in such a way that conflicts of interests are, if not eliminated, at least ameliorated. The substantial effect of these conflicts of interests causes inefficiency in the delivery and selection of products and/or services. Separating the advice and/or selection of products and services so as to ameliorate or eliminate such conflicts of interests, and implementing such a new and innovative program would increase the likely and perceived quality of the experience of shopping for products and/or services with a corresponding positive effect on the marketplace and increasing the confidence of individual consumers in the salespersons in selling products and services, thus, optimizing the shopping process and experience, as viewed by individual consumers.

The above separation should also eliminate the need for artificial and less precise mechanisms to address issues such as paying sales representatives a uniform salary, which limits the incentives that can be paid to the most productive employees. Thus, there is a clear need for an new and innovative program that, to a greater or lesser extent, separates the rating or recommendation or ordering from other function, or combining them in a way that safeguard the integrity of the process from the standpoint of the individual, such as a consumer which would be significant improvement over current programs/approaches under which the recommendation rating and/or ordering functions are typically controlled by person(s) whose interests are inconsistent with that of the individual, such as a consumer.

In this connection, there is also a need to insure that the conflicts of interest inherent in the traditional arrangements are addressed so that such conflicts of interest are ameliorated or eliminated. Such traditional conflicts of interest may have contributed to the sub-optimal state of affairs, which finds that many individual consumers will not obtain the benefit of the subject services if the individuals such as consumers have to pay a separately stated fee for such services and/or have to spend time researching such services even though such services clearly provide more value in many, if not most cases, than their cost money and time. Typically, when other avenues such as the profit on products sold or leased subsidize the subject services, there is a temptation for persons in the supply line of these services to maximize their profits, often in a manner that is to the detriment of individuals such as consumers, making it desirable to separate the subject services from other functions so that the fees for the subject services may, where such an approach is warranted, remain non-obvious, and so that other functions that may subsidize such services will not be utilized in a manner that disrupts or inappropriately influences the delivery of such services. This is believed to be significant because such services will typically enhance the value received by individuals such as consumers.

The systems and methods of the new and innovative purchasing/leasing program should recommend or order (including ranking of the products and/or services) the optimal products or services, which would include the recommendation or selection of a single product or service, based on the unique facts and circumstances of each individual consumer, in order to systemically address and ameliorate any potential conflict of interest. The order should result either from a single or multiple affirmative directions, or, in the case where a third party can act on behalf of the individual consumer, with no direction from the individual consumer.

The systems and methods of the new and innovative purchasing/leasing program should select or assists persons in selecting appropriate products and/or services.

The systems and methods of the new and innovative purchasing/leasing program may provide for oversight of the conditions designed to eliminate or ameliorate conflicts of interest within the products and/or services distribution channels.

The systems and methods of the new and innovative purchasing/leasing program should address the above indicated needs by utilizing safeguards that address the conflicts of interest, thereby reducing the individuals' including consumers' anxiety in selecting products and/or services.

The systems and methods of the new purchasing/leasing program should address the problems resulting from the fact that, currently, individuals including consumers frequently believe that they do not have the time, interest, and/or expertise to make the most appropriate decisions.

The systems and methods of the purchasing/leasing program should solve the above problems by minimizing the input required by individuals and automating the process to the greatest possible extent (or where an individual including a consumer prefers providing for the degree of involvement preferred by an individual) while eliminating or ameliorating the conflict of interest that normally exists between parties that typically provide these services.

The systems and methods of the new purchasing/leasing program should provide a data processing system that reduces individuals' input and enables individuals or persons acting on their own or their behalf, to explicitly or implicitly turn over some or all of these decisions concerning products or services to others. The net result should be that individuals are more likely to achieve their goals mostly because the new purchasing/leasing program utilizes the natural tendency of most individuals to minimize their involvement (many take no action whatsoever) in independently and exhaustively researching products and/or services including the quality, convenience and cost of the products/goods and/or services, among other criteria.

The systems and methods of the new and innovative purchasing/leasing program should use a data processing system that collects, monitors and directs information from individuals including consumers to optimally recommend or select products and/or services based on the individual's unique facts and circumstances (and/or on the facts and circumstances of similar persons), with the option for the individual consumers to provide a minimum of input concerning some or all of the relevant areas. The systems and methods of the new and innovative purchasing/leasing program should insure that an appropriate recommendation(s) or selection(s) are made for each individual consumers (including the alternative of not making any selection) the data processing system may include a relational database that will be continually updated with relevant product indicative data (e.g., specifications, price, and other relevant criteria) and which is provided from outside sources. The data is used to feed the analytic engine that will recommend or select optimal products and/or services based on the individuals' criteria and/or that of persons similar to the individual.

One aspect of the present disclosure is a unique data processing system that provides totally or generally independent and possibly expert evaluation on a basis that minimizes the input and time of individuals and assists them in making purchasing or leasing decisions and eliminates or reduces all of the conflicts of interest that typically exist in all the presently known schemes when persons in the supply line of providing products or services supply such assistance.

One representative system for providing these services to individuals includes a data storage for storing data from a plurality of sources, including the individual; means for processing the data from each source such that a recommendation(s) and/or selection(s) is furnished by generating a tangible report recommending, or directly ordering products and/or services.

One representative computer implemented method for providing independent or generally independent recommendation or selection of products or services to individuals while eliminating or ameliorating the conflict of interest between these and other functions, such as sales of the products and/or services includes the steps of: developing mechanisms that elicit the criteria of each user, including consumers; developing a ranking or rating system for differing quality measures, integrating this system with price or cost (when price or cost is a factor) and then further integrating it with convenience (where convenience is a factor).

The present disclosure addresses the problem resulting from the fact that currently, individuals select goods or products in a sub-optimal manner. Currently, persons may rely on inexpert recommendations such as the recommendation of a friend, may engage in independent research or simply may purchase the product or services without the benefit of any research whatsoever. Further, persons may select products and/or services based on the input from other persons who have an interest in the purchase or lease that may not be consistent with that of the purchaser/lessor. The above-described process typically results in a purchase or lease that is sub-optimal and/or results in the expenditure of time that the person would generally rather spend on other activities.

The system of the present disclosure permits persons to be as active and specific as they would like in the purchase/lease process; and addresses the conflict of interest that is otherwise often present in such transactions: The systems and the methods of the present disclosure may automatically purchase or lease products and/or services, or recommend products and/or services based on the information provided to the system operators by the purchaser or obtained from third parties concerning the purchaser or persons similar to the purchaser, combined with information about the products and services to be purchased or leased. The purchase(s) or lease(s) can result either from a single or multiple affirmative directions, or in the case where a third party can act on behalf of the individual, with no direction from the initiating the transaction. The systems and methods of the present disclosure will incorporate safeguards that at least ameliorate or otherwise reduce the conflict of interest that may otherwise be present in connection with the subject transactions. In this regard, the system of the present disclosure may use information about the products and services obtained from persons who are independent, to a greater or lesser extent, of the persons who are financially interested in the transactions. This information can be loaded into the data processing system associated with the systems and methods of the present disclosure so that the analysis of the factors and resulting output in the form of an automatic purchase or recommendation (which may consist of a single or multiple recommendations and/or selections) so that the self-interest or conflict of interest typically associated with a purchase or lease is at least ameliorated if not totally eliminated. The system of the present disclosure may also assist persons in obtaining a favorable price based on the volume of purchases/leases and/or based on where the best price can be obtained, using a process that is managed overseen or pursuant to safeguards established by a person who is generally or totally independent of the process. The systems and methods of the present disclosure may also assist persons (including natural and unnatural persons) who sell products and services. By permitting a purchase/lease prospect to use the systems and methods of the present disclosure, which may incorporate safeguards/procedures that ameliorate conflicts of interest and to assure the quality of the inputs, and view the results thereof, and may also incorporate safeguards/procedures that assist in assuring the integrity of the system including those that assist in verifying or assure verification of the inputs (including information supplied by or concerning the purchaser), the prospect's doubts concerning the products and/or services could be at least reduced, if not completely eliminated. Utilization of the systems and methods of the present disclosure could result in more sales and or leases being consummated—with less on the part of the persons initiating the transactions.

One representative system for assisting in the selection of items (e.g., products and/or services), the system comprising: data storage for storing preference data for at least one client (e.g., potential purchaser and/or lessee) and for storing characteristic data (e.g., price, performance, availability, aesthetics, ratings) for a plurality of products; a selection model designed (or at least designed in part), and/or reviewed (or at least reviewed in part) and/or approved by an independent party (or at least generally independent) and adapted to be applied to the preference data and the characteristic data; and a processor for automatically (or substantially automatically) generating a recommendation (e.g., recommended product) and/or a comparison (e.g., price and/or quality) of products for a client in accordance with the preference data for the client (and/or of persons similar to the client), the characteristic data for the plurality of products, and the selection model.

One representative computer implemented method for assisting in the selection of products, the method comprising: storing preference data for at least one client; storing characteristic data for a plurality of products; providing a selection model designed and/or approved by an independent party and adapted to be applied to the preference data and the characteristic data; and generating a recommendation (e.g., recommended product) or automatic purchase or lease of a product or service and/or a comparison (e.g., price and/or quality) of products for a client in accordance with the preference data for the client (and/or of persons similar to the client), the characteristic data for the plurality of products, and the selection model.

One representative computer implemented method for assisting in the selection of services, the method comprising: storing preference data for at least one client; storing characteristic data for a plurality of services; providing a selection model designed and/or approved by an independent party and adapted to be applied to the preference data and the characteristic data; and generating a recommendation (e.g., recommended product) or automatic purchase or lease of a product or service and/or a comparison (e.g., between price and/or quality) of services for a client in accordance with the preference data for the client (and/or of persons similar to the client), the characteristic data for the plurality of services, and the selection model.

Other objectives and advantages of the present application will become apparent from the following description, the accompanying drawings and the appended claims.

### BRIEF DESCRIPTION OF THE DRAWINGS

FIGS. 1-5 are block diagrams generally illustrating the structure of a representative system including methods related thereto.

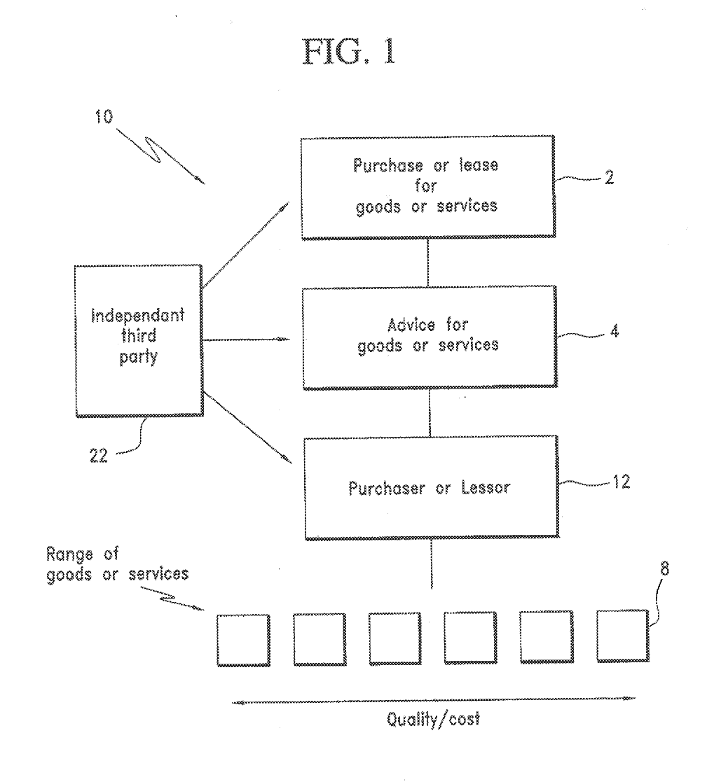

### DETAILED DESCRIPTION OF THE DISCLOSURE

In carrying out the present disclosure in representative preferred forms thereof, we have provided representative new and innovative systems and methods utilizing the innovative systems to assist individual consumers in the purchase or leasing of products and/or services that includes, but is not limited to, representative systems and representative methods for providing representative services to assist individuals including consumers in the lease or purchase of products or services including, but is not limited to, the evaluation of specific product and/or service, including, but not limited to, quality, price and convenience and the evaluation of each criteria through a facilitator 14 which may be a natural person or a machine, such as, for example, a computer or equivalent, to provide a recommendation for a purchase or lease based on data 30 provided by or on behalf of an individual, including a consumer, which may include, but is not limited to, data concerning similar persons (e.g., individual consumers) and criteria 20 established by a third party (e.g., an independent expert) 22 who is generally independent of other persons who are involved in the purchase and/or lease transaction, and when all this information is fed into a data processor 16 the processor 16 either determines that the information concerning the individual is or is not sufficient and if more information is required, such information may be solicited from or concerning the individual.

Once the above is accomplished, the processor 16 generates a recommendation for a purchase/lease from a representative vendor 26 who can then send the products or service to the individual or the person who ordered the products or services (e.g., for an individual consumer as a gift or any one of a plurality of reasons). The information necessary to complete the delivery process can be stored in a data storage device 18 that is capable of updating the information as more information is received concerning purchasers, products and services etc.

The systems and methods of the present disclosure are based upon the recognized fact that most persons, and particularly individual consumers want to simplify the purchasing/leasing process for products or services yet still arrive at a transaction outcome favorable from the individual's perspective.

Persons, including individual consumers that enter into purchase/lease transactions can roughly be divided into two groups as follows:

1. Persons such as individual consumers who enjoy and ‘participate” in the purchasing/leasing research process.

These persons have sufficient time and interest to do the necessary research, but would appreciate access to tools that would assist with the necessary purchasing/leasing research necessary to arrive at an optimum purchase/lease outcome.

2. Persons such as individual consumers who do not have the time, the inclination, or would prefer not to participate in the purchasing/leasing research process to the extent necessary to arrive at an optimum purchase/lease outcome.

This second group of persons typically enters into purchases/leases for products and/or services at prices that may be higher than they would have paid if they had sufficient time and resources to adequately research their purchase or lease prior to entering into the specific purchase/lease transaction. This second group of persons typically is responsible for purchasing or leasing inferior products and services. This segment does not appreciate tools and information that would assist with the necessary purchasing/leasing research necessary to arrive at an optimum purchase/lease outcome. This second group of persons simply wants to be handed a solution that serves their interests (e.g., where conflicts of interest are reduced or eliminated), (e.g. tell me what is the best CD system for under $400 and where a convenient place to buy it at a reasonable price is located).

Dramatically improving the purchase or lease process therefore requires meeting the needs of the second group of persons such as individual consumers who do not typically participate, or do not wish to participate in the research process required to arrive at an optimal purchase/lease transactions outcome. This group is believed or is the clear majority of individual consumer purchasers or lessors.

One possible solution to the above-described situation is to provide representative systems and methods which provide for persons including individual consumers a person to make a minimum of inputs into the systems and methods yet achieve an optimal purchase/lease transactions outcome result.

For example, an individual consumer person who wishes to purchase the “best” CD system for under $400 could simply so state or could add one or more specific criteria in their order of importance, e.g., quality of radio, power of the amplifier or any other of a plurality of relevant criteria, as specified by the individual consumer. By adding information, the individual consumer person would receive a more customized transaction result.

Once the specific criteria important to the individual consumer purchasers or lessors for the products and/or services are specified and entered into the system software, the individual can provide preauthorized instructions to buy or lease, with or without a specific identification of the products or services, and the system software may respond with a selection(s) or recommendation(s) that may or may not be accompanied by an explanation consisting of one or more reasons why the products or services best meet the specified criteria. At this point, the individual consumer purchasers or lessors may be provided with an additional opportunity to modify one or more of the criteria may or may not be supplied or a person or a person may simply state that they want to buy or lease a specific type of product or service. This process can be accomplished by one or more of a variety of means including, but not limited to, one or more clicks of the mouse when connected to the Internet or by speaking to a person on the telephone, in person, or by mailing the order to a predetermined address, as would be understood by one skilled in the art.

The systems and methods of the present disclosure serve the person initiating the transaction because the data is evaluated using an objective process that is generally dependent on ratings and/or analysis based on specific criteria of the products and services supplied by a third party who is more or less independent of the normal transaction process, and/or which analysis is reviewed by a person who is more or less independent of the normal transaction process (e.g., the analysis of the products in Consumers Reports). In one representative system and method of the present disclosure, the normal transaction process is integrated with the systems and methods of the present disclosure to identify the products or services, and may further identify one or more of the following: (1) the prices at which products or services can be purchased, and (2) how convenient the process is (e.g., can it be picked up today two blocks away or does it take three weeks to ship) so that a customized transaction solution can be arrived at for the individual, including individual consumers taking into account as many criteria as the individual cares to input or have imputed and can supply default factors for data that the individual does not supply data or criteria to ultimately result in an optimal transaction from the individual's perspective.

The systems and methods of the present disclosure include, among other features, at least one data storage device capable of retaining an individual consumer's data and preferences. Such data can change over time (e.g., as a natural person ages) and the process can therefore be customized without further input from the person by the utilization of software programs (originated, monitored or pursuant to safeguard(s) established by a person who is generally or totally independent of the transactions) specifically developed for this purpose. The data storage device further, at least in some cases minimizes, if not eliminates, the time commitment necessary for transaction research by a person initiating the transaction, which results in an optimal solution from the transaction initiators perspective.

Payment for use of the systems and methods of the present disclosure may come from the persons who initiate the purchase or lease transaction or from the sellers of the products and/or services involved in the transaction, as a flat fee, a percentage of the sale or any other means that generally would not materially compromise the integrity of the process, such payment could include compensation from different persons, including, but not limited to, any party in the supply line of the transaction.

Generally, no materially variable fees may be made to any person(s) who are responsible for ameliorating or eliminating any conflicts of interest or profits made by such person(s). This payment method may enable a service utilizing the systems and methods of the present disclosure to be provided to any one or all of the parties involved in the transaction for no separate, visible fee above and beyond the normal transaction amounts charged which could significantly enhance utilization of the systems and methods of the present disclosure.

In implementing these representative systems and representative methods, a facilitator 14 will generally offer the program 10 to evaluate and assist in ordering products and/or services using criteria formulated by a generally independent person or persons 22 which can include natural or legal persons and can provide or provide access to the output from the data processor 16 to the purchaser or lessor.

The disclosure consists of system utilizing a data processor, such as a computer, a storage device and devices for inputting and outputting data. The system is for the purchase or lease of products or services (2), recommending products or services (4) to a purchaser or lessor (12).

The purchaser or lessor is provided with a solution that reflects a comparison of value of the available products and services that may include one or more of the price, quality and/or convenience of the products and/or services (one criteria may be convenience which may include limiting the review to items sold by or in stock of a particular seller with or without disclosure of such limitation) in order to provide the purchaser or lessor with the optimum value, according to the criteria presented. Material elements that affect the recommendation or selection are generally formulated and or approved by an independent third party (10).

Persons who wish to purchase or lease products or services (12) generally initiate contact with the system through a facilitator (14), which may consist of a natural person or software housed on a device, such as, for example, a computer or data processor (16). Information is inputted into the data processor (16), which may include information that is saved to or obtained from a data storage device (18). The basis or criteria for the output and possibly the input (20) (the recommendation, purchase or determination of whether there is sufficient data) is, presently preferably, formulated or approved by one or more generally independent third parties (22) so that any conflict of interest with respect to influencing the transaction is ameliorated or eliminated. Such third parties (22) may also originate or review the collection and or evaluation of data from the person or similar persons in order to ameliorate or eliminate conflicts of interest inherent in the present product/service purchase/lease process and may verify or provide safeguard and/or a process that assists in assuring or assures the integrity of the product/service purchase/lease process including the accuracy of the inputs concerning the purchaser and/or lessor (12).

Initially, there is a determination concerning whether there is sufficient or minimum data (24) in order to recommend or make a purchase or lease and whether more data would be helpful. If there is not sufficient data then the person can be informed that more data is required, or more data can be acquired from other sources. If there is sufficient data then a recommendation is transmitted through the facilitator (14) or a purchase and/or lease is made from a vendor (26). In some or all instances there may be direct or indirect contact between the purchaser or lessor (12) and a person who is more or less independent of the transaction (22) in order to assist in assuring or assure the integrity of the process including the accuracy of the inputs concerning the purchaser or lessor (e.g., the purchaser or lessor is contacted to verify that he or she wanted the best CD system for under $400 with at least 30 amps of power).

Note that systems and/or methods employing one or more aspects of the present disclosure may, for example, be implemented using one or more systems and/or methods disclosed in U.S. Pat. No. 6,154,732 entitled “System for Providing Investment Advice and Management of Pension Assets” and/or disclosed in Patent Application Pub. No US2002/0169701, entitled “Systems and Methods for Improving Investment Performance”, filed on Feb. 11, 2002, each of which is hereby expressly incorporated by reference into the present application to the extent not inconsistent with the present disclosure. It should be understood however, that systems and/or methods employing one or more aspects of the present disclosure need not be implemented using any of the systems and/or methods disclosed in U.S. Pat. No. 6,154,732 and Patent Application Pub. No US2002/0169701.

Purchaser or lessor 12, as used in the present application, is a natural or unnatural person, who could benefit from one or more of the services provided under the program 10, including individual consumers who may want to purchase products and/or services. The program 10 may also be used, including being operated by vendors 26 who wish to provide these services to persons who may purchase products and/or services from them, in order to facilitate and increase the likelihood that a transaction will occur, because, among other things, purchasers'/lessors anxiety concerning making a suboptimal decision, or spending a great deal of time in the purchase/lease process will decrease due to the program's utilization of criteria established and/or reviewed by a third party who is more or less independent of the other parities involved in the transaction, including the independent expert.

In cases involving the use of the program 10 by a vendor, the evaluation can be limited to products and/or services offered by the vendor and may or may not include information characterizing how complete or representative the offering of a vendor is and may include a disclaimer that the evaluation is based solely on the items offered by the vendor and may further include an evaluation of whether the offered selections are fairly representative of those on the market, and enable a person to purchase or lease an item on a reasonable basis considering one or more of cost, quality and convenience.

In the case where a person who sells or leases products and/or services 26 is involved, such person could negotiate with the third party 22 upon whose criteria the program may operate and provide input concerning the products and or services that the third party expert will take into account and even as to the formulae upon which products and/or services will be recommended or sold subject to the agreement of the third party 22, who is a person or persons who is generally or totally independent of persons involved in the program 10 who may have interests that are not consistent with the purchasers or lessors 12. The negotiations may include the extent to which a separate fee is paid for the purchasing/leasing program 10 and/or the extent to which any such fees is subsidized by the fees paid in connection with purchase and/or lease of products and/or services including fees paid by persons who are affiliated with the person who sells products and/or services 26. The vendor may also negotiate with the owner(s) of claims granted by the Patent and Trademark Office, which may assure that the process continues to operate in the interest of consumers and maintain confidence in the program.

The purchaser or lessor 12, or a third party acting on behalf of a purchaser or lessor 32 (such as a person who wants to provide a gift) then chooses which products or services and selects the parameters/criteria used to select or recommend the products and/or services. For example, a person acting on behalf of a person may want to purchase an item, such as a CD player that fits in a particular space, or may want to purchase sofas that meet certain qualitative criteria. Also, a purchaser or lessor may want to limit the types of items to consider to, such as, for example, excluding sofas that are manufactured by a particular company or in a particular region or country. The program 10 permits such a customized solution while at the same time making an individual optimal outcome more likely.

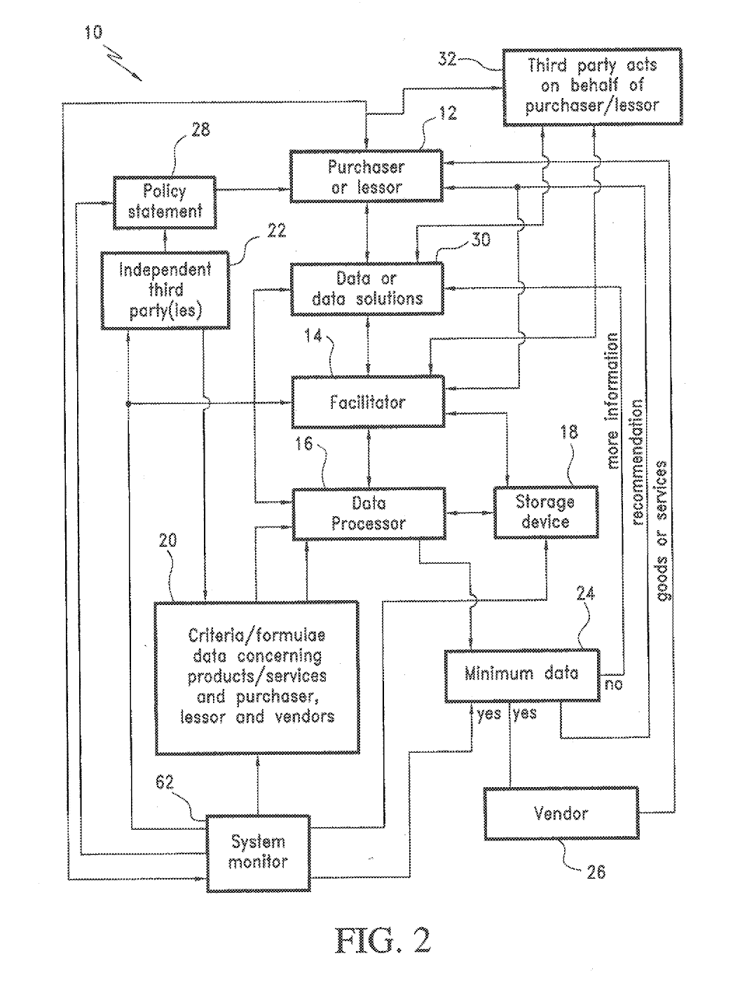

As illustrated in FIG. 2, minimum indicative data 24 (which can be obtained from the purchaser or lessor 12 and/or third parties regarding the purchaser or lessor or persons similar to the purchaser or lessor is then provided by the purchaser or lessor and/or third party.

In this connection, the Independent Third Party 22 determines or approves the minimum data requirement 24 and makes a recommendation or selection with or without any additional input from the purchaser or lessor 12. If the minimum data requirement 24 is met, then the program 10 can make the recommendation or selection, which may be an initial selection or recommendation or a final recommendation or selection. If the minimum data requirement 24 is not met, then the additional information may be inputted by a variety of means, such as, for example, by a facilitator 14 communicating with a purchaser or lessor 12 and obtaining additional data and inputting it on behalf of the purchaser or lessor

Once the minimum data requirement 24 is met then the program 10 makes a recommendation(s) or selection. This process can continue until, after examining the program output, the purchaser or lessor 12 makes a selection or the process can be one where the purchaser or lessor determines that they simply want the products or services selected by the program, in which case the products or services can be identified and purchased or leased for the purchaser or lessor 12.

In connection with the collection of initial data, facilitators 14 (who may be sales representatives of vendors, and/or data input/output devices such as computers as well as other parties) may assist the purchaser or lessor 12 with an understanding of the program 10, and in collecting and transmitting data necessary to meet the minimum requirement 24 as determined by the independent third party 22. As presently envisioned, the facilitator 14 has no ability to formulate or vary the formulation of any recommendation or selection made under the program 10. Also, the compensation of the facilitator 14 can be designed and implemented such that there will be no incentive to depart from the program's recommendations or selections though the facilitator 14 may generally receive increased compensation for success in selling products and/or services, but generally may not receive increased compensation for causing purchasers or lessors not to follow the recommendations or selections under the program.

Rather, the principal role of the facilitator 14, relative to the program, is to facilitate the operation of the program and, in this connection, to solicit current, complete and accurate information including criteria from the purchaser or lessor 12. The facilitator 14 may also provide information to the purchaser or lessor 12, explaining the operation and the benefits of the program 10 on a regular basis, which may take into consideration the particular elements/criteria that the purchaser or lessor would like the products and/or services under consideration to possess. In this regard, the facilitator 14 may regularly contact the purchasers and/or lessors to obtain and/or supply current information and other data as may be related to specific criteria related thereto. For example, a facilitator 14 may assist individual purchasers or lessors with the decision as to whether or not to purchase or lease an item as well as which item to purchase/lease. The facilitator 14 may directly input information into the storage device 18, resident on the data processor (which can be a computer) 16, regarding a purchaser or lessor 12.

Once data is inputted into the storage device 18, selected services available under the program 10 can be implemented (though the data does not have to be saved or pass through the storage device in order to make a recommendation or selection). At a time shortly before or after the data implementation, individual purchasers or lessors may receive an individual policy statement 28 that may be supplied by a facilitator or by a means that is independent of the sales process. This policy statement 28 is designed to confirm the indicative data supplied and the action that will be or was taken based on the indicative data as well as the basis for the action, which may be provided in a summary fashion. The program 10 may contact the individual purchasers or lessors 12 on a regular or irregular basis through electronic means or otherwise, as is known to those skilled in the art. The individual purchasers or lessors 12 may be assigned to the facilitator 14, who may contact the purchaser or lessor 12 on a regular or irregular basis for the purposes previously described.

The quality of the services provided by the facilitator 14 can be monitored by a system monitor that may contain a computer program 62 designed or approved by the Independent Third Party 22. The system monitor 62 may determine, among other things, whether the data was appropriately provided, and whether the recommendations or selections were appropriately provided and implemented, in accordance with the data and or criteria received.

Another innovative aspect of the present system and methods includes provisions for making certain adjustments to the recommendations or selections provided under the program 10, which may be made on an ongoing basis. Adjustments may be made based on updated information/data/criteria, on information obtained via contact with facilitators 14 or by changes in available products and/or services. The updated information is inputted into the program resident on the data processor 16 and changes, if any, to the recommendations and/or selections implemented based on the new information received in accordance with the procedures established or approved by the Independent Third Party 22. For long term relationships, other data/criteria changes may be made due to the passage of time (e.g., the aging of the purchaser or lessor) and external changes (e.g., changes in interest rates, which may be particularly relevant to a decision concerning whether to purchase or lease) or in accordance with the procedures established or approved by the Independent Third Party 22.

All of the implementations and changes will be based on the indicative data that is inputted into the program resident on the data processor 16 and then processed by that program, which was designed and/or approved, implemented and/or monitored by the Independent Third Party 22. As noted above, in yet another innovative aspect of the disclosed purchasing/leasing program 10, the Third Party 22 will be generally independent from other parties who receive variable fees and/or profits based on the recommended products and/or services recommended or selected by the program resident on the data processor 16 in accordance with the procedures established or approved by the Independent Third Party 22.

Similar or identical mechanisms, such as, for example, the program designed and/or approved, implemented and monitored by the Independent Third Party 22, are used to address the conflicts of interest that can occur when determining how to establish a program that assists individual purchasers or lessors 12 how to minimize expenses in paying for the products and/or services including how to minimize taxes (which in these instances would generally be sales taxes), to the extent practical.

As is known, sales persons or other persons who typically provide assistance with these decisions, receive commissions or other credit from their employers or vendors when a purchase or sale is made, therefore, have or may have interests that could affect the quality of the assistance that they provide and may be adverse to the individual purchasers or lessors' interest 12 interest. Such persons involved in the sales/lease process are compensated based on factors that may not be consistent with the interest of individual purchaser or lessor 12 and could have a selfish interest in recommending or implementing inappropriate products and/or services in order to maximize their income rather than assisting in making the most appropriate selection or otherwise optimizing the process for the individual purchaser or lessor

In accordance with the implementation of the program 10, all of the implementations, recommendations and changes will be based on the indicative data that is inputted into the data processor 16 and processed by the program designed and/or monitored and/or approved by the Independent Third Party 22. As noted above, the Third Party 22 will be generally or totally independent from all other parties, who receive variable fees and/or profits based on the products or services purchased or leased and/or the products or services recommend or selected by the purchasing/leasing program 10. The indicative data is first processed by the program resident on the data processor 16. The program resident on the data processor 16 then selects or recommends the individual purchaser or lessor 12, through a facilitator 14 or otherwise as to one or more of the specific steps that should be taken, and may implements the instructions of the individual purchaser or lessor 12. In this regard, the program 10 may suggest a course of action that will be implemented unless the individual purchaser or lessor opts out.

The program services are coordinated on a continuing basis and are specifically tailored to each individual purchaser or lessor's 12 individual circumstances. The systems and methods utilized in the present program 10 are particularly valuable because they provide individual purchasers or lessors 12 with much needed objective assistance while possibly formulating, and in all cases taking into account the individual purchasers or lessors' 12 circumstances, including the amount that they have to spend generally with the on-going assistance of facilitators 14 to exploit opportunities in a manner that most individual purchasers or lessors 12, would not or could not exploit on their own without competent, conflict free assistance in the purchase/lease decision process.

The system and methods of the present purchasing/leasing program 10 are user-friendly in that the program 10 is specifically designed to eliminate the confusion typically suffered by individual investors and lessors 12 by minimizing the individual purchasers and/or lessors' 12 input and decision points which may concern quality, convenience and pricing. The result of utilizing the present program 10 is that appropriate and more optimal decisions are easier for the vast majority of individual purchasers and/or lessors 12 and therefore more likely to occur, thereby assisting purchasers and/or lessors or persons acting on their behalf in achieving their purchasing/leasing goals while in many cases also assisting sellers and lessors in achieving their goals or completing a transaction.

Yet another innovative feature of the present program 10 includes the elimination for the necessity of establishing, as is common practice, more general recommendations. In fact, a recommendation or selection can be precisely calculated to the need of and therefore unique to the individual purchaser or lessor 12, with fees for these services obtained in a variety of means that can also reflect the preferences of the participant and/or vendors and include means that provide for no visible fees.

Utilization of the present program 10 further refines the process of selling/leasing products and services, enabling the purchase/lease process, to be more precise by further removing the recommendation and/or selection process from the immediate influence of the selling agent/vendor.

One aspect of the program 10, which is described in the present disclosure, is the Independent Third Party 22 that constructs or approves, among other things, appropriate product/service selection criteria. As described above, the Third Party 22 is generally or totally independent including financially independent from other persons, such as, for example, persons who sell/lease products and/or services associated with the purchasing/leasing program 10 who may benefit, either directly or indirectly, financially or otherwise, from recommendations or selections made under the program 10. Furthermore, the Independent Third Party 22, in its sole and absolute discretion, may seek the assistance of others in formulating or approving the criteria or selection/recommendation mechanisms.

As presently envisioned, the formulation or approval of the product/service criteria utilized by the Independent Third Party 22 may include, but is not intended to be limited to, algorithms, studies, analytics, research, models, papers and other work product or relevant materials provided by others, including vendor(s) 26. It is presently anticipated that vendors 26 will have the most incentive to operate the program 10 because operating the program 10 can increase the likelihood of making a sale and can generally lead to continuing, and profitable, relationships with the purchasers or lessors 12 assisted under the program 10.

Some of the benefits to vendors are illustrated in a recently published (in 2003) book “How Customers Think,” authored by Gerald Zaltman, the disclosure of which is hereby incorporated by reference to the extent not inconsistent with the present disclosure. This book was written from the business perspective, by a professor of marketing at the Harvard Business School and was published by the Harvard Business School Press. At pages 97-99 Professor Zaltman notes that customers want and value a company that provides a process that saves them time (is convenient) and does not take advantage of them. The systems and methods of the present disclosure are believed to provide customers with such a process that will clearly save the customer time, is convenient to the customer and is more beneficial to the customer, as opposed to taking advantage of the customer.

The mechanism for generating a recommendation(s) or selection(s) as expressed in a program resident on the data processor 16, when implemented will not be static, but only the Independent Third Party 22 in the Third Party's discretion 22 may make or approve adjustments to the selection formulae, taking into consideration the individual consumer or lessors goals and to account for changes, such as, for example, in market and/or a plurality of other conditions that may be related to a specific purchase/lease transaction. Thus, the systems and methods of the present disclosure will employ, for the benefit of purchasers or lessors 12, concepts based on quality, cost and convenience, and the influence by other persons who may have interest that differ from that of the individual purchaser or lessor and 12 will be limited in a manner that eliminates or ameliorates any conflict of interest. For example, the compensation that such persons can pay to the Independent Third Party may be limited (e.g., as a percentage of income or based on a flat amount) and/or by limiting the ownership interests that person(s) can have in the Independent Third Party 22 (including prohibiting any ownership interest).

The information/data/criteria furnished to the Independent Third Party 22, including information provided by the individual purchaser or lessor, is believed new and novel as a means for providing impartial purchase or lease assistance services directly or indirectly to individual purchasers or lessors. Thus, by incorporating an objective process into the present program 10, the inherent conflict of interest, which can result from the way purchases and/or leases are traditionally effectuated is effectively ameliorated or eliminated.

Specifically, as is well known, under conventional sale or lease programs by implementing or recommending a selection with a higher profit margin the typical salesperson (as well as intermediaries such as brokers), would receive higher fees such as commissions and net profits.

As described above, the system monitor 62, completely independent of person(s) who receives variable fees and profits, may be responsible for monitoring the program 10, which preferably includes a program designed or approved, implemented and/or monitored by the Independent Third Party 22, to insure that safeguards designed to ameliorate the conflicts of interest are kept in place and complied with at all times. The program, and/or the monitor 62, may, in addition, be monitored and/or certified by third parties (e.g., an accounting firm), having no financial interest in the specific recommendations or selections being made for individual purchasers and/or lessors 12 to ensure that the conditions safeguarding against conflict(s) of interest are in place and have been adhered to.

Under the present program 10, which includes the systems and methods described in the present disclosure, there may be a separate fee paid for recommendation and/or selection which may be limited to a fee based on the value of the products and/or services (e.g., up to 100 basis points) and reimbursable expenses which may be similarly limited to a percentage of the total amount invested (e.g., up to 25 basis points or the fees may be calculated on a different basis. In one alternative, the program may charge only fees from the sellers or products and services, or could provide services to purchasers and/or lessors in exchange for information about the purchasers and/or lessors and/or permission to contact purchasers and/or lessors 26.

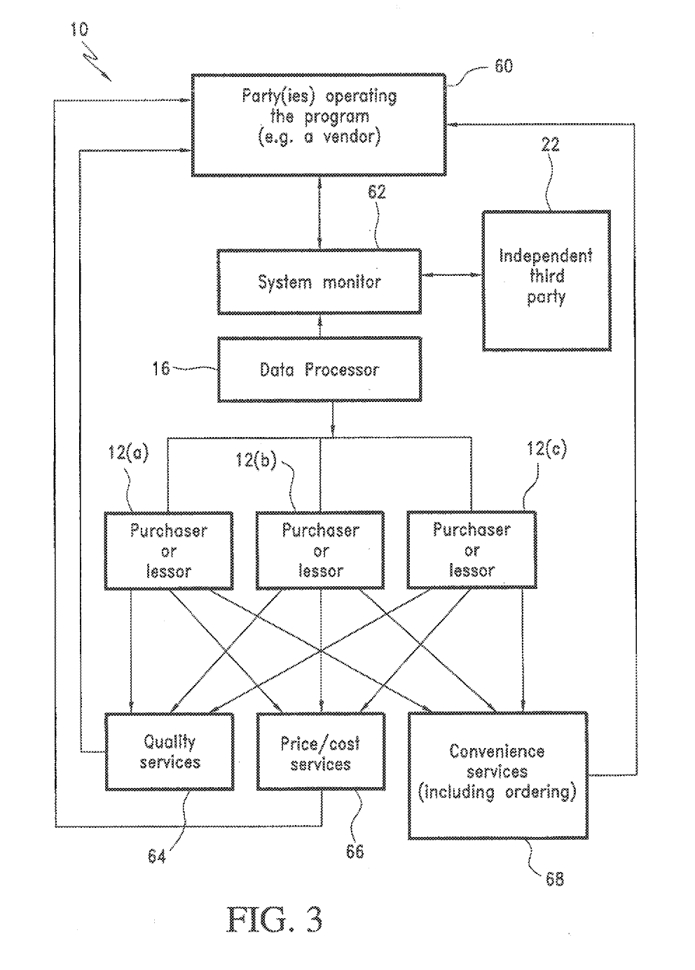

FIG. 3 is a schematic representation of the program 10 structure as seen by each of a plurality of individual purchasers and/or lessors 12. As illustrated, the party 60 operating the program 10 (e.g., a vendor.) communicates with a system monitor at 62 that controls the data processing device (e.g., a computer 16 having the program resident thereon which in turn communicates with each individual purchaser or lessor 12 electronically or through other conventional means (e.g., through a sales representative), as is known in the art.

The computer based system monitor 62 collects data concerning each underlying service, including, where utilized, services 64, 66, 68 and can keep track of each purchaser and lessors' account and preferences. The system monitor also collects data and transaction instructions from the program operator(s) 60 and carries out transactions changing the information and criteria when appropriate taking into account the criteria that may be most relevant to individual purchasers and/or lessors, 12a, 12b, 12c upon any change in the indicative data which may occur from the passage of time (aging of the investor) or due to new data provided by the individual purchaser or lessor 12 or through the facilitator(s) 14. The fees for operating the program may be deducted from the sale or lease proceeds and such information will generally be provided to the system monitor 62. These fees are presently anticipated to be in the form of a per capita fee, or an fee based on the value of the transaction and or the expert services or any combination of the foregoing fees may be set by the program operator 60 based on existing market conditions.

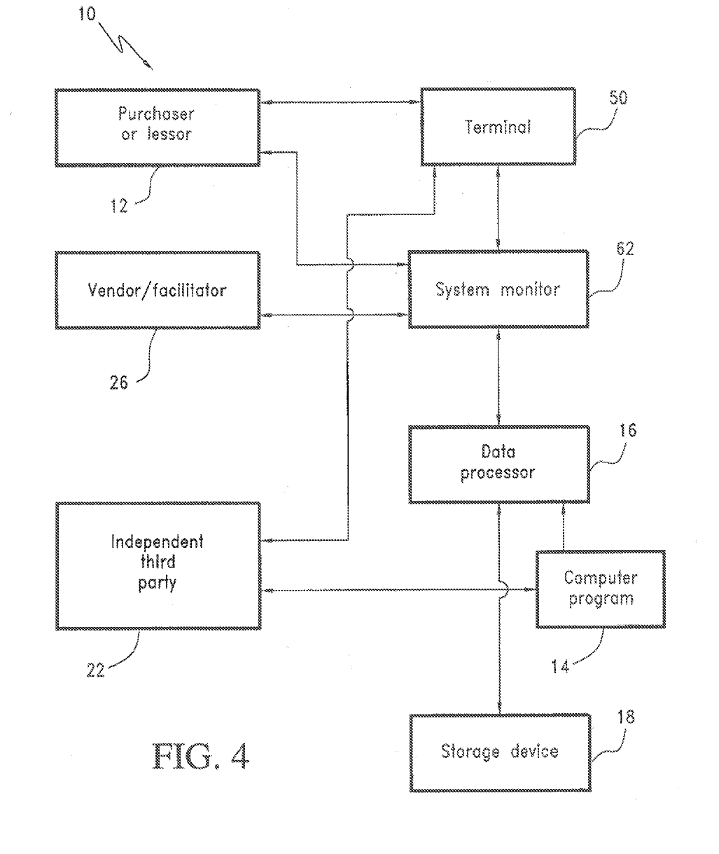

As shown in FIGS. 2 and 3, the data processor 16 gathers and processes indicative data related to including information from the individual purchasers and/or lessors 12 which is used, in conjunction with other information to provide recommendations and/or selections of products and/or services. The system monitor 62 may interface with the Data Processor 16 and calculate and report to one or more purchasers and/or lessors some or all of the input on which it relied and/or some or all of the basis for the selection or recommendation. One example of how this can work, shown in FIG. 4 would be where a vendor that utilizes the program 10, places a Terminal 50 on its premises that communicates with the System Monitor. The vendor could have a salesperson act as a facilitator in obtaining information from a purchaser or lessor and the salesperson could then recommend a service or product. The terminal could directly communicate with the monitor and be branded as such (e.g., as, communicating with an independent third party, which branding could include identification of the third party, such as Consumer Reports). This could enable the purchaser or lessor to directly verify the accuracy of the input and the nature of the recommendation, possibly including to a lesser or greater extent the reasons for the recommendation. This process should greatly facilitate the sales process by increasing confidence in the recommendation and decreasing the anxiety associated with possibly making a suboptimal purchase or lease. This likely effect, of a more caring and nurturing process and company was also noted by Professor Zaltman in his book, How Customers Think, at pages 97-99.

The program 10 and the system monitor 62 (See FIG. 3) may generally insulate any person (e.g., vendors 26) who may receive variable fees and/or profits, depending on the recommendation and/or selection provided based on the criteria supplied or approved by the Independent Third Parties 22 and its fees, and the facilitators, and their compensation by maintaining separate systems of compensation that is memorialized in the system monitor. This insulation and separation removes or substantially reduces any economic or profit incentive on the part of persons who are in a position to actually affect individual purchasers or lessors 12 decisions to purchase products and or services simply to generate higher fees and/or profits that may be inappropriate for the individual purchaser or lessor 12 but more profitable to persons who may receive variable fees and profits, depending on the recommendation and/or selection. The program utilized by the system monitor, in its initial form, will be initially designed and constantly updated to follow and adhere to the safeguards and conditions designed to mitigate or eliminate overreaching by person(s) who may receive variable fees and profits, depending on the purchase or lease decision. This insulation and separation removes or substantially reduces any economic or profit incentive on the part of persons who are in a position to actually affect individual purchaser or lessor 12 decisions to purchase or lease in a manner that generates higher fees and/or profits that may be inappropriate for the individual purchaser or lessor 12 but more profitable to persons who receive variable fees and profits, depending on the purchase or lease. The program utilized by the system monitor, in its initial form, will be initially designed and constantly updated to follow and adhere to the safeguards and conditions designed to mitigate or eliminate overreaching by person(s) who receives variable fees and profits, depending on a purchase or lease decision.

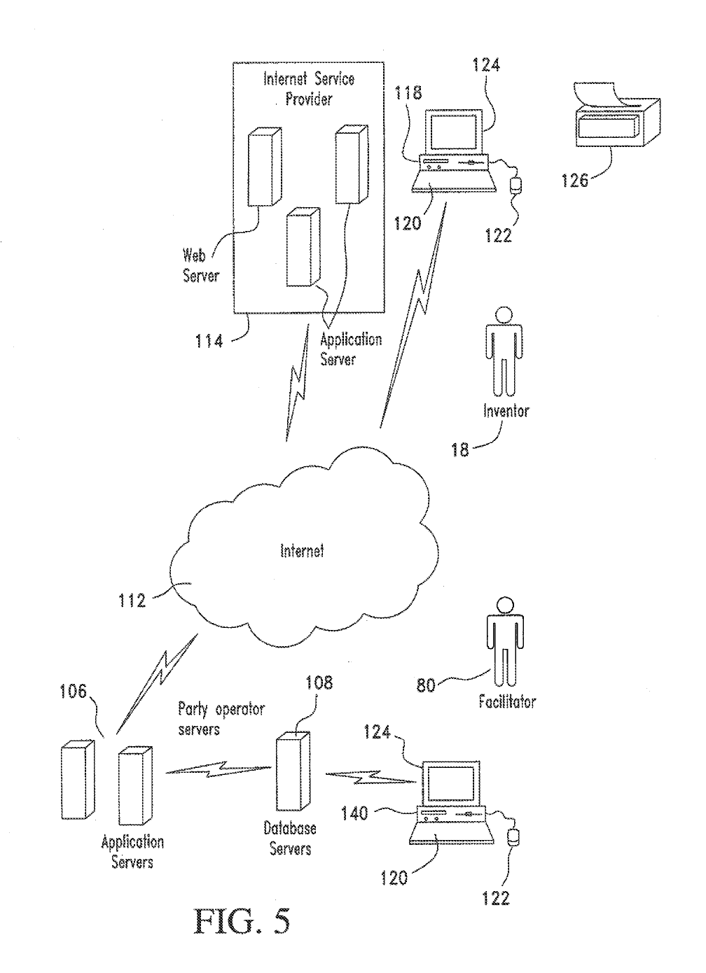

As illustrated in FIG. 5, the recommendation selection portion of the program 10, which includes the systems and methods of the present disclosure, may require certain computer hardware, including but not limited to, a mainframe computer or server(s) 106 for processing large volumes of data stored in a data storage unit 108 and a communications system, including, but not limited to, intranet, internet 112, and other communication vehicles, as is known to those skilled in the art. The stored data is taken from data provided by the individual purchasers or lessors 12 or third parties, as described above. A personal computer or workstation 118 having a hard drive or other storage device, an input device such as a keyboard 120 and mouse 122, and an output device such as a display 124 and printer 126 can be operatively connected to the computer 118, as is known to those skilled in the art. The program operator's 60 computer 14 may be used to communicate with and monitor an individual purchaser or lessors' 18 computer 118, as is known to those skilled in the art. In particular, computer programs used to implement the recommendation/selection services 50, 90, 92 loaded on the application servers 108 are accessed by, or on behalf of, the program operator 60 and used to transmit under the program 10 in a tangible form, to each purchaser and/or lessor.

The present purchasing/leasing program 10 includes a unique data processing system that, among other things, recommends and/or automatically selects products and/or services on a basis that serves the purchaser/lessor by, among other things, eliminating or reducing conflicts or interest. By reducing the steps in the purchaser and/or lease selection process (how much can be up to the purchaser/lessor) the selection process can become more cost effective (both from the standpoint of time invested and the result achieved), and efficient, both from the perspective of the purchaser/lessor and the vendor.

The present program 10 uniquely serves the interests of purchasers and/or lessors 12 including individuals as well as vendors 26. Individual purchasers and lessors 12 will benefit by taking what is otherwise a complex set of decisions and reducing them to a more automatic and user friendly procedure, which, if simply adhered to, is believed to be likely to materially increase the value received, including the quality of the products and/or services obtained relative to the price. The present program 10 will also benefit vendors in that the program 10 will can reduce their overhead and increase their effectiveness in selling products and/or services by basing the process, at least in part, on formulae developed or approved and implemented in various computer programs, by an Independent Third Party.

The results derived from the implementation of the program 10 are believed clearly superior to the marketing of the merits of a service or product, which is typically based on a one size, fits all approach, rather than the specific requirements of a purchaser or lessor and such process generally includes a conflict of interest. It is also believed that the program 10 will materially assist vendors since the results derived from the implementation of the program 10 are believed to permit vendors to increase the amount of business that they do with clients by providing the most important services relative to their clients achieving their goals while protecting against conflict of interest.

Another aspect of the present program 10 arises from placing products and services in their proper perspective. Currently branding of products serves, in some instances as a barrier to entry for products and services that may offer superior value to some or all segments of purchasers and/or lessors. This barrier exists, at least in part, because purchasers and/or lessors have reached a level of confidence in the brand which may or not continue to be warranted for all or some of the products of a brand. If a respected third party's ratings (e.g., Consumer Reports) are easily accessed for purchasing or leasing products or services this can provide the comfort factor of a well-respected brand without the premium price typically charged, which in part reflect the advertising and other elements that provide little if any tangible benefit to purchasers and/or lessors. An element of the present program 10, by placing brands in their proper perspective, addresses this problem. Instead of choosing a product or service based on a particular brand purchasers or lessor can instead describe their criteria or rely, to a greater or lesser extent on default criteria. This enables the purchaser and/or lessor to take advantage of the program and or the criteria originated or reviewed by a third party.

By placing brands in their proper perspective, it is also believed that a purchaser and/or lessor 12, or a person acting on behalf of a purchaser or lessor will be better enabled to make a single selection or otherwise minimize selections to less than they otherwise would be by specifying criteria because the brands can be changed by the operation of the program which acts on behalf of purchasers and/or lessors. With the criteria originated or approved by the Independent Third Party 22.

Changes and modifications in the specifically described representative systems and methods can be carried out without departing from the scope of the disclosure which is intended to be limited only by the scope of the appended claims.

What is claimed is:

1. A method for providing recommendations followed by purchases and leases over the internet, regarding a purchase or lease of goods or services for at least one purchaser or lessor comprising the steps of:
receiving a request regarding the purchase or lease of goods or services;
storing the request in a computerized database;
providing data which is independent of at least one person who will profit depending on the decision of the purchaser or lessor;
retrieving from the database information necessary to process the request;
processing the request using software to present a recommendation, the software in a computer which accesses the data which is independent of the at least one person who will profit depending on the decision of the purchaser or lessor;
reviewing using software in a computer, the data used to arrive at the recommendation to ensure that the data are originated by a person who is independent of at least one person who will profit depending on whether the at least one purchaser or lessor purchases or leases the goods or services;
transmitting via a computer, over the internet, the recommendation by the at least one person who will profit depending on the decision concerning the purchase or lease of goods or services to at least one purchaser or lessor; and
the purchaser or lessor transmitting, via a computer, over the internet a purchase order purchasing or leasing good or services and a vendor receiving such order over the internet and supplying goods or services to the purchaser

2. The method according to claim 1, further comprising the step of:
separating compensation paid to the at least one person who is independent of others who receive variable fees and profits depending on whether the at least on purchaser or lessor purchases or leases the goods or services so that such compensation is independent of others who receive variable fees and profits depending on whether the at least one purchaser or lessor purchases or leases the goods or services.

3. The method according to claim 101, further comprising the step of:
ranking at least one group of products or services according to quality.

4. The method according to claim 1, further comprising the step of:
ranking at least one group of products or services according to quality.

5. The method according to claim 1, further comprising the step of: ranking at least one group of products or services according to convenience of the purchase or lease.

6. The method according to claim 1, further comprising the step of:
ranking at least one group of products or services according to a combination of at least two of price, quality, and convenience.

7. A computer-implemented apparatus for providing recommendations followed by purchases and leases over the internet; said apparatus comprising:
computer software which receives a request for information concerning a product or service;
a computer with software which operates with a memory for storing data and a processor configured to:
retrieve using a computer which operates with a memory data necessary to process the request;
utilize software to ensure that a recommendation supplied concerning the product or service is independent of at least one person who will profit depending on the decision of the purchaser or lessor;
process the request using software to supply a recommendation;
utilize software to insure that the process used to provide the recommendation is independent of the at least one persons who will profit depending on the decision of the purchase or lease of goods or services; and transmit the recommendation by the at least one person who will profit depending on the decision of the purchase or lease of goods or services alone or in concert with the at least one person who is independent of those persons who will profit depending on the decision of whether to purchase of goods or services; and
utilize software to arrange for a purchase or lease of good or services over the internet.

8. The apparatus according to claim 7, further comprising computer software configured to order products or services corresponding to the recommendation.

9. The apparatus according to claim 7, further comprising at least one computer configured to access an internet to order the products or services corresponding to the recommendation.

10. The apparatus according to claim 7, further comprising computer software configured to provide the recommendation based on price.

11. The apparatus according to claim 7, further comprising computer software configured to provide the recommendation based on quality.

12. The apparatus according to claim 7, further comprising computer software configured to provide the recommendation based on convenience.

13. The apparatus according to claim 107, further comprising computer software configured to provide the recommendation based on a combination of at least two of price, convenience, and quality.

14. A computer system capable of providing recommendations over the internet regarding the purchase or lease of goods or services, the computer system comprising:
structure, operatively resident on the computer for processing the request for information regarding goods or services;
structure, operatively resident on the computer system for storing the request in a computerized database;
structure operatively resident on the computer system; for retrieving from the database information necessary to process the request; structure, operatively resident on the computer system for processing the request using software to supply a recommendation concerning the request for information regarding goods or services;
structure, operatively resident on the computer system for insuring that the recommendation is originated by at least one person who is independent of those persons who will profit depending on the decision of the purchase or lease of goods or services; and
structure, operatively resident on the computer system for transmitting the recommendation by at least one person who will profit depending on the decision regarding the purchase or lease of goods or services alone or in concert with the at least one person who is independent of those persons who will profit depending on the decision of a purchase or lease of goods or services.
structure, operatively resident on the computer system, for using software to verify the source of the data input;
structure, operatively resident on the computer system for using software to process a purchase of goods or services over the internet.
